(19) United States
(12) Patent Application Publication
(10) Pub. No.: US 2023/0178793 A1
(43) Pub. Date: Jun. 8, 2023

(54) ELECTROLYTE OPERABLE IN WIDE TEMPERATURE RANGES AND LITHIUM BATTERY INCLUDING SAME

(71) Applicant: KOREA INSTITUTE OF SCIENCE AND TECHNOLOGY, Seoul (KR)

(72) Inventors: Jihyun HONG, Seoul (KR); Minah LEE, Seoul (KR); Jin Kwan CHOI, Seoul (KR); Jina LEE, Seoul (KR)

(73) Assignee: KOREA INSTITUTE OF SCIENCE AND TECHNOLOGY, Seoul (KR)

(21) Appl. No.: 17/734,788

(22) Filed: May 2, 2022

(30) Foreign Application Priority Data
Dec. 8, 2021 (KR) 10-2021-0174914

(51) Int. Cl. H01M 10/056; H01M 10/0525

(52) U.S. Cl. CPC H01M 10/056; H01M 10/0525; H01M 2300/0025; H01M 2300/002; H01M 2220/20; H01M 2220/30

(57) ABSTRACT

The present disclosure relates to an electrolyte operable in wide temperature ranges and a lithium battery including the same. By dissolving two or more lithium salts in a mixture solvent including three or more different acyclic alkyl carbonate compounds, reactivity with lithium metal and freezing point are decreased at the same time and, therefore, the lifetime characteristics and electrochemical performance of a lithium-ion battery, a lithium-metal battery, or a lithium-ion capacitor using the same are improved significantly.

### CROSS-REFERENCE TO RELATED APPLICATION

This application claims priority to Korean Patent Application No. 10-2021-0174914, filed on Dec. 8, 2021, and all the benefits accruing therefrom under 35 U.S.C. § 119, the contents of which in its entirety are herein incorporated by reference.

### BACKGROUND

### 1. Field

The present disclosure relates to an electrolyte operable in wide temperature ranges and a lithium battery including the same.

### 2. Description of the Related Art

The operation temperature of a lithium-ion battery is determined by the change in the ion conductivity of an electrolyte through which lithium ion passes during charge and discharge. In commercial batteries, a mixture solution prepared by mixing a mixture of ethylene carbonate (EC), which is a cyclic carbonate solvent having a high dielectric constant and thus can dissolve and dissociate lithium salts, and one or more of dimethyl carbonate (DMC), diethyl carbonate (DEC) and ethyl methyl carbonate (EMC), which are acyclic alkyl carbonate solvents that exist as liquid at room temperature and can lower the freezing point and viscosity of an electrolyte, at a ratio between 3:7 and 1:1 (v/v) with a 1-1.5 M LiPF₆ salt is utilized as an electrolyte. Because the ion conductivity of the electrolyte is proportional to the number of dissociated lithium ions and inversely proportional to the viscosity, a desired lithium ion conductivity can be achieved only through a combination of the two or more solvents. Among them, EC is essential in ensuring ion conductivity by dissociating the LiPF₆ salt.

However, EC has a melting point (freezing point) of 34-37° C. and exists as solid at room temperature. Because EC-DMC, EC-DEC and EC-EMC, which are mixture solvents of 30 mol % of EC and 70 mol % of an acyclic carbonate, have freezing points of about −9° C., 5° C. and 10° C., respectively, the electrolytes are solidified when exposed to temperatures below −10° C. in winter season. As a result, the ion conductivity is decreased rapidly and the battery fails to operate. Especially, for electric vehicles whose market share is expanding rapidly recently, mileage may be decreased rapidly in the dead of winter or they may not even operate. In addition, even the emergency power may be useless in case of extreme cold. It may result in severe casualties and property damages as in the massive blackout that occurred in Texas and Chicago in the US in early 2021.

To solve this problem, use of ether-based solvents, which are not used in commercial lithium batteries, or an electrolyte developed by liquefying ammonia, etc., which exist as gas at room temperature, has been reported. Although ether-based solvents significantly lower freezing points as compared to carbonate-based solvents, they are decomposed irreversibly when an electrochemical cell is charged to 4.3 V (vs. Li/Li⁺) or higher due to low oxidation stability. Therefore, the reversible capacity of lithium transition metal oxides (lithium nickel manganese cobalt oxides, Li(NiₓMn_{y}Co_{z})O₂, x+y+z=1), which are commercial cathode active materials, cannot be fully utilized and lifetime characteristics are limited. Although an electrolyte prepared by liquefying ammonia at high pressure exhibits superior ion conductivity and stability at low temperature, it exists as gas and loses ion conductivity at room temperature. In addition, a special compression device is necessary for the liquefaction. For these reasons, it is used only for the manufacture of special-purpose secondary batteries, e.g., for space research, due to high cost.

The inventors of the present disclosure have found out that an electrolyte prepared by dissolving a lithium salt in a mixture solvent consisting of three or more different acyclic alkyl carbonate compounds exhibits high ion conductivity and the freezing point can be lowered to −100° C. or below through a ternary eutectic phenomenon, which allow long-term operation of a secondary battery by decreasing reactivity with lithium metal and stabilizing the same, and have completed the present disclosure.

### REFERENCES OF THE RELATED ART

### Non-Patent Documents

(Non-patent document 1) Ding, S. Michael, Xu, K., Zhang, S., & Jow, T. R. Liquid/Solid Phase Diagrams of Binary Carbonates for Lithium Batteries Part II. Journal of The Electrochemical Society, 148, A299-A304 (2001).
(Non-patent document 2) Holoubek, J., Liu, H., Wu, Z. et al. Tailoring electrolyte solvation for Li metal batteries cycled at ultra-low temperature. Nat Energy 6, 303-313 (2021).
(Non-patent document 3) Yangyuchen Y., Yijie Y., Daniel M. D. et al. Liquefied gas electrolytes for wide-temperature lithium metal batteries. Energy Environ. Sci., 13, 2209 (2020).
(Non-patent document 4) Cyrus S. R., Yangyuchen Y., Tae Kyoung K., et al., Liquefied gas electrolytes for electrochemical energy storage devices, Science, 356, 6345 (2017).

### SUMMARY

The present disclosure is directed to providing an electrolyte which exists as liquid in a broad temperature range from 50° C. to −100° C. and exhibits superior ion conductivity, and a lithium-ion battery or a lithium-metal battery which includes the same and can be charged and discharged repeatedly up to 4.7 V without irreversible side reactions.

In an aspect, the present disclosure provides an electrolyte including: a mixture solvent including three or more different acyclic alkyl carbonate compounds; and a lithium salt.

In another aspect, the present disclosure provides a lithium-ion battery including the electrolyte.

In another aspect, the present disclosure provides an electrical device including the lithium-ion battery.

In another aspect, the present disclosure provides a lithium-metal battery including the electrolyte.

In another aspect, the present disclosure provides a lithium-ion capacitor including the electrolyte.

Since the electrolyte of the present disclosure exists as liquid in a temperature range from 50° C. to −100° C., it can retain sufficiently high ion conductivity in the above temperature range (2.5 mS/cm or higher at room temperature). Because the electrolyte retains high electrochemical stability even at an end-of-charge voltage of 4.5 V, a lithium-ion battery or a lithium-metal battery having high energy density may be prepared by fully utilizing the reversible capacity of a cathode. In addition, the electrolyte of the present disclosure can improve the energy density of the battery by providing superior electrochemical and chemical stability without reduction or dissolution of lithium metal upon contact with the lithium metal. In addition, since the acyclic alkyl carbonate compounds and the lithium salt have been already adopted and are being produced already in large scale, they can be readily utilized in commercial lithium-ion batteries.

Due to the high chemical and electrochemical stability of the electrolyte, the lithium-ion battery or lithium-metal battery of the present disclosure can operate reversibly during repeated charge and discharge both at low temperature of −40° C. at room temperature of 30° C.

### BRIEF DESCRIPTION OF THE DRAWINGS

FIG. 1 shows a result of evaluating the freezing point and lithium metal stability of ternary acyclic alkyl carbonate mixture solvents prepared in Example 1-1 and Example 2-1 and single solvents and binary mixture solvents using DEC, EMC and DMC.

FIG. 2 shows the ternary phase diagram of ternary acyclic alkyl carbonate mixture solvents including EMC, DMC and DEC.

FIG. 3 shows a differential scanning calorimetry (DSC) analysis result of electrolytes prepared in Example 1-1, Example 1-2, Comparative Example 1-1 and Comparative Example 1-2.

FIG. 4 shows the ion conductivity of electrolytes of Example 1-1, Example 2-1, Comparative Example 1-1 and Comparative Example 1-2 depending on temperature.

FIG. 5 shows a result of testing the room-temperature characteristics of Li∥Li symmetric cells using electrolytes of Example 1-1 and Example 2-1.

FIG. 6 shows a result of evaluating the electrochemical characteristics of coin cells using electrolytes of Example 1-1 and Example 1-3 at 30° C. and −40° C.

FIG. 7 shows a result of evaluating the electrochemical characteristics of a coin cell using an electrolyte of Comparative Example 1-1 at −40° C.

FIG. 8 shows the low-temperature characteristics of the full cell of a lithium-ion battery using an electrolyte of Example 1-2.

### DETAILED DESCRIPTION

Hereinafter, the present disclosure is described more specifically referring to the attached drawings and examples.

As described above, the existing electrolytes including ethylene carbonate (EC) as an essential component for dissolving lithium salts are limited in operable temperature ranges because they exist as solid at room temperature due to high freezing points. Although ether solvents or electrolytes prepared by liquefying ammonia to lower freezing point have been reported, these electrolytes have the problem that the performance of the lithium-ion battery is decreased due to significantly deteriorated oxidation stability or ion conductivity. Therefore, the present disclosure provides an electrolyte which has a significantly low freezing point by including three or more acyclic alkyl carbonate compounds and does not decrease electrochemical performance owing to high ion conductivity.

More specifically, the present disclosure provides an electrolyte including: a mixture solvent including three or more different acyclic alkyl carbonate compounds; and a lithium salt.

The electrolyte of the present disclosure has high ion conductivity and electrochemical stability to such a level that a lithium-ion battery can be operated although it does not include ethylene carbonate (EC). In addition, because it exists as liquid in a temperature range from 50° C. to −100° C., ion conductivity can be maintained sufficiently high in the above temperature range and the freezing point can be lowered to −100° C. or below.

The electrolyte of the present disclosure may have a freezing point of −100° C. or below and a boiling point of 60° C. or higher.

In the present disclosure, the acyclic alkyl carbonate compound refers to a compound which contains a carbonate group (—CO₃), has no cyclic structure and consists of two alkyl groups. Specific examples of the acyclic alkyl carbonate compound include dimethyl carbonate (DMC), ethyl methyl carbonate (EMC), diethyl carbonate (DEC), dipropyl carbonate (DPC), methyl propyl carbonate (MPC), dibutyl carbonate (DBC), methyl butyl carbonate (MBC) or methyl pentyl carbonate (MPeC).

One of the three or more acyclic alkyl carbonate compounds may be dimethyl carbonate (DMC) and each of the remaining two or more acyclic alkyl carbonate compounds may be independently any one of ethyl methyl carbonate (EMC), diethyl carbonate (DEC), dipropyl carbonate (DPC), methyl propyl carbonate (MPC), dibutyl carbonate (DBC), methyl butyl carbonate (MBC) and methyl pentyl carbonate (MPeC). When the mixture solvent includes dimethyl carbonate (DMC), there is an advantage that a battery can operate stably because chemical reaction does not occur upon contact with lithium metal.

When one of the three or more acyclic alkyl carbonate compounds is dimethyl carbonate (DMC), 5-45 mol %, specifically 6-30 mol %, of the dimethyl carbonate (DMC) may be included based on 100 mol % of the three or more acyclic alkyl carbonate compounds. When the dimethyl carbonate (DMC) is included at a mol % below the lower limit, side reactions with the electrode may occur due to significantly decreased stability with lithium metal. On the other hand, when it is included at a mol % above the upper limit, the freezing point is increased undesirably.

One of the three or more acyclic alkyl carbonate compounds may be ethyl methyl carbonate (EMC), the other may be diethyl carbonate (DEC) and the remaining one may be dimethyl carbonate (DMC). When the three or more acyclic alkyl carbonate compounds are EMC, DEC and DMC, the reactivity with lithium metal may be decreased significantly and the freezing point may be advantageously lowered to 100° C. or below.

Based on 100 mol % of the three or more acyclic alkyl carbonate compounds, the ethyl methyl carbonate (EMC) may be included at 20-60 mol %, the diethyl carbonate (DEC) may be included at 30-80 mol % and the dimethyl carbonate (DMC) may be included at 5-45 mol %. Specifically, the ethyl methyl carbonate (EMC) may be included at 25-50 mol %, the diethyl carbonate (DEC) may be included at 40-70 mol % and the dimethyl carbonate (DMC) may be included at 6-30 mol %. When the diethyl carbonate (DEC) is included at a mol % below the lower limit, the freezing point may not be lowered sufficiently. On the other hand, when it is included at a mol % above the upper limit, the electrode may be broken due to increased reactivity with lithium metal. When one or more of the ethyl methyl carbonate (EMC) and the dimethyl carbonate (DMC) are included at mol % below the lower limits, reactivity with lithium metal may be increased significantly. And, when they are included at mol % above the upper limit, the freezing point may not be lowered sufficiently. When the mol % of the ethyl methyl carbonate (EMC), diethyl carbonate (DEC) and dimethyl carbonate (DMC) satisfies the above ranges, the reactivity with lithium metal may be decreased significantly and the freezing point may be lowered to −100° C. or below upon dissolution of the lithium salt. In addition, the capacity characteristics of the lithium-ion battery may be improved significantly due to remarkably improved long-term stability.

The lithium salt may be included at a concentration of 0.8-2.5 M, specifically 1-2 M. When the concentration of the lithium salt is below the lower limit, the electrochemical performance of a lithium-ion battery including the same may be decreased due to decreased ion conductivity. On the other hand, when it is above the upper limit, side reactions may occur because the lithium salt is not dissolved sufficiently or the conductivity may decrease as the viscosity of the electrolyte is increased.

The lithium salt may include: lithium hexafluorophosphate (LiPF₆); and one or more lithium salt containing a macroanion, selected from lithium bis(trifluoromethanesulfonyl)imide (LiTFSI), lithium bis(fluorosulfonyl)imide (LiFSI), lithium (fluorosulfonyl)(nonafluorobutanesulfonyl)imide (LiNFSI) and lithium triflouromethanesulfonate (LiOTf). When the lithium salt includes lithium hexafluorophosphate (LiPF₆) and a lithium salt containing a macroanion, it may be sufficiently dissolved and dissociated in the mixture solvent which has a relatively low dielectric constant and, therefore, may significantly improve ion conductivity and charge transfer rate. Therefore, it can significantly improve low-temperature characteristics when applied to a lithium-ion battery, allowing it to be operable in a broad temperature range.

Based on 100 mol % of the lithium salt, the lithium hexafluorophosphate (LiPF₆) may be included at 30-70 mol %, specifically at 33-67 mol %. When the content of the lithium hexafluorophosphate (LiPF₆) is below 30 mol %, the battery cannot be charged to 3.9 V or higher due to corrosion of an aluminum foil which is a cathode current collector. On the other hand, when the content exceeds 70 mol %, the improvement of the low-temperature characteristics of the lithium-ion battery cannot be expected.

The electrolyte may further include 2-10 vol % of fluoroethylene carbonate (FEC) based on 100 vol % of the electrolyte. When the content of the fluoroethylene carbonate is below the lower limit, lifetime characteristics may be deteriorated because it is difficult to form a stable SEI on the anode surface. On the other hand, when the content exceeds the upper limit, ion conductivity may be decreased at low temperature due to high viscosity and freezing point.

In particular, although not explicitly described in the following examples and comparative examples, the electrolytes of the present disclosure were prepared under various conditions and then the durability of lithium-ion batteries prepared using the same was tested by repeating charge and discharge at −40° C. for 200 cycles.

As a result, it was confirmed that conductivity was not decreased significantly after charge and discharge for 200 cycles and superior capacity retention rate was achieved when all of the following conditions were satisfied. On the other hand, when any of the following conditions was not satisfied, the conductivity of the lithium-ion battery was decreased significantly after charge and discharge for 200 cycles and long-term stability was unsatisfactory due to rapid decrease of capacity.

One of the three or more acyclic alkyl carbonate compounds is ethyl methyl carbonate (EMC), the other is diethyl carbonate (DEC) and the remaining one is dimethyl carbonate (DMC).

Based on 100 mol % of the three or more acyclic alkyl carbonate compounds, the ethyl methyl carbonate (EMC) is included at 25-50 mol %, the diethyl carbonate (DEC) is included at 40-70 mol % and the dimethyl carbonate (DMC) is included at 6-30 mol %.

The lithium salt is included at a concentration of 1-2 M.

The lithium salt includes lithium hexafluorophosphate (LiPF₆) and lithium bis(trifluoromethanesulfonyl)imide (LiTFSI).

Based on 100 mol % of the lithium salt, the lithium hexafluorophosphate (LiPF₆) is included at 33-67 mol % and the lithium bis(trifluoromethanesulfonyl)imide (LiTFSI) is included at 33-67 mol %.

The electrolyte further includes 2-10 vol % of fluoroethylene carbonate (FEC) based on 100 vol % of the electrolyte.

In addition, the present disclosure provides a lithium-ion battery including the electrolyte.

The lithium-ion battery of the present disclosure exists as liquid in a temperature range of about 150° C. or higher, from 50° C., which is higher than room temperature, to the extremely low temperature of −100° C. Because it retains sufficiently high ion conductivity even at −60° C., which corresponds to the lowest temperature in the extremely cold winter season in the US, and includes the electrochemically stable electrolyte, it can fully utilize the capacity of a lithium transition metal oxide which is a commercial cathode. In addition, superior capacity can be ensured even when a lithium-ion battery composed of a graphite anode or a lithium metal anode is charged and discharged at −40° C. In addition, charge and discharge are possible in a broad voltage range of 2-4.7 V.

The lithium-ion battery may include: a cathode including a lithium transition metal oxide or a lithium transition metal phosphate; and an anode including graphite, a silicon-based active material or a mixture thereof.

In addition, the present disclosure provides an electrical device including the lithium-ion battery.

The electrical device may be a communication device, a transportation device, an energy storage device or an acoustic device.

In addition, the present disclosure provides a lithium-metal battery including the electrolyte.

The lithium-metal battery may be composed of: the electrolyte; a cathode; and a lithium metal anode.

In addition, the present disclosure provides a lithium-ion capacitor including the electrolyte.

The lithium-ion capacitor may be composed of: the electrolyte; an activated carbon cathode; and an anode including graphite, hard carbon, activated carbon, soft carbon, or a mixture thereof.

### EXAMPLES: PREPARATION OF TERNARY ACYCLIC ALKYL CARBONATE MIXTURE SOLVENT AND ELECTROLYTE BASED THEREON

### Examples 1-1 to 1-3

### Example 1-1

After drying ethyl methyl carbonate (EMC), diethyl carbonate (DEC) and dimethyl carbonate (DMC) solvents under argon atmosphere in a glove box using a molecular sieve and then mixing them at a molar ratio of 27:65:8, a ternary acyclic alkyl carbonate mixture solvent was prepared by stirring for 30 minutes.

After dissolving 0.75 M of a LiPF₆ salt and 0.75 M of a LiTFSI lithium salt in the prepared mixture solvent, an electrolyte was prepared by stirring for 30 minutes.

### Example 1-2

An electrolyte with improved stability of a graphite anode was prepared by adding 5 vol % of fluoroethyl carbonate to the electrolyte prepared in Example 1-1 and stirring for 30 minutes.

### Example 1-3

An electrolyte was prepared by dissolving 1.5 M of a LiPF₆ salt in the ternary acyclic alkyl carbonate mixture solvent prepared in Example 1-1.

### Example 2

### Example 2-1

A ternary acyclic alkyl carbonate mixture solvent was prepared in the same manner as in Example 1-1 by mixing EMC, DEC and DMC solvents at a molar ratio of 45:45:10.

An electrolyte was prepared by dissolving 0.75 M of a LiPF₆ salt and 0.75 M of a LiTFSI lithium salt in the prepared mixture solvent and then stirring for 30 minutes.

### Comparative Examples 1-1 and 1-2

### Comparative Example 1-1

A commercial electrolyte wherein 1 M LiPF₆ was dissolved in ethylene carbonate (EC)/diethyl carbonate (DEC) (v/v=1/2) was prepared.

### Comparative Example 1-2

After adding 5 vol % of fluoroethyl carbonate to the commercial electrolyte, the electrolyte was stirred for 30 minutes.

### Test Example 1. Evaluation of Reduction Stability and Applicability to Battery of Electrolyte

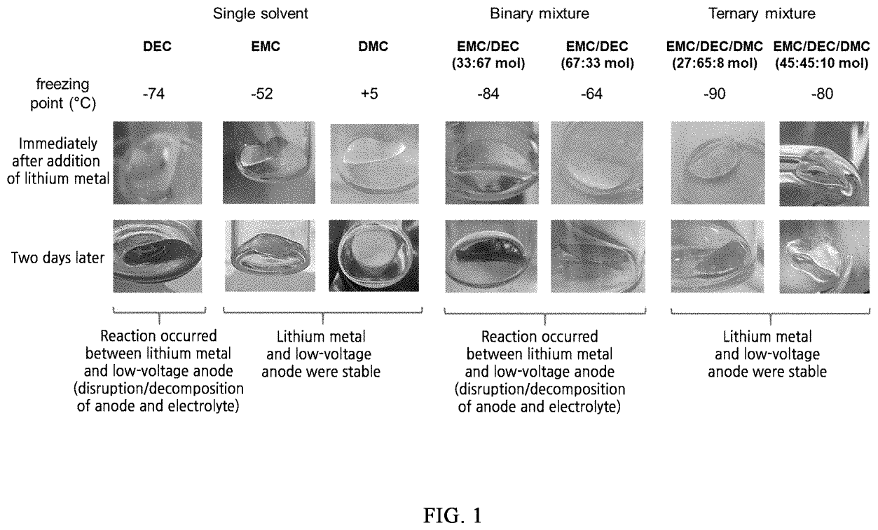

After immersing lithium metal in the ternary acyclic alkyl carbonate mixture solvents prepared in Example 1-1 and Example 2-1 and single solvents and binary mixture solvents using DEC, EMC and DMC, followed by storage in a glove box for two days, the change of the lithium metal was observed (FIG. 1).

FIG. 1 shows a result of evaluating the freezing point and lithium metal stability of the ternary acyclic alkyl carbonate mixture solvents prepared in Example 1-1 and Example 2-1 and the single solvents and binary mixture solvents using DEC, EMC and DMC.

Referring to FIG. 1, it can be seen that, for the DEC single solvent, the electrolyte and the anode were damaged permanently due to chemical reaction with the lithium metal having a low reduction potential. The lithium metal was slightly stable in the EMC and DMC single solvents but showed a high freezing point. For the binary EMC/DEC mixture solvent, the freezing point was lower than that of the EMC single solvent, but the lithium metal and the electrolyte were damaged permanently due to chemical reaction when the content of DEC exceeded 33 mol %. In addition, even when the DEC was limited to 33 mol %, the reactivity with lithium metal was high and the freezing point was not lowered significantly as compared to the EMC single solvent. In contrast, for the ternary EMC/DEC/DMC mixture solvents of Example 1-1 and Example 2-1 of the present disclosure, a low-voltage anode could be operated stably without reaction with lithium metal even when the DEC content was as high as 65%, and the freezing point was low as −80° C. or below.

Through this, it can be seen that the DEC which is an essential component of an electrolyte for lowering the freezing point has the problem that it reacts chemically with lithium metal due to low reduction stability, and the stability against lithium metal cannot be ensured even when a binary carbonate mixture solvent is prepared by mixing with EMC. In addition, it can be seen the binary carbonate mixture solvent cannot be used at low temperature because the freezing point is raised greatly. In contrast, it can be seen that the ternary acyclic alkyl carbonate mixture solvent of the present disclosure overcomes the disadvantage of DEC and can significantly lower the freezing point without reaction between the mixture solvent and lithium metal.

### Test Example 2. Analysis of Freezing Point (Melting Point) of Electrolyte

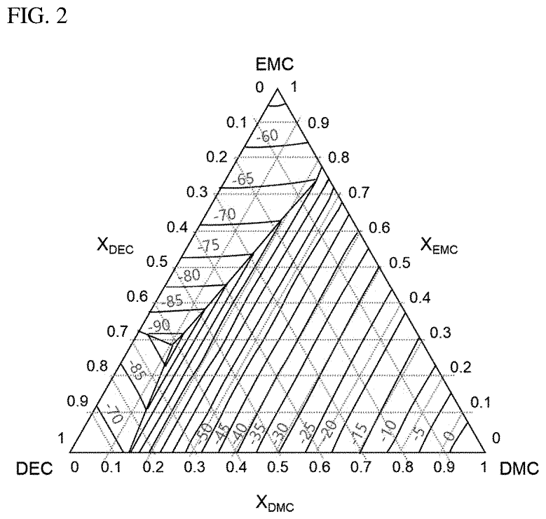

FIG. 2 shows the ternary phase diagram of the ternary acyclic alkyl carbonate mixture solvents including EMC, DMC and DEC.

Referring to FIG. 2, it can be seen that the composition of the ternary acyclic alkyl carbonate mixture solvent exhibiting the lowest freezing point is the EMC:DEC:DMC solvent with a molar ratio of about 30:59:11 and, in this case, the freezing point is below −90° C. In addition, it can be seen that a mixture solvent for an electrolyte which has a freezing point of −80° C. or below and has no reactivity with lithium metal can be prepared by utilizing the ternary eutectic phenomenon owing to the high low-voltage stability of the ternary mixture solvent.

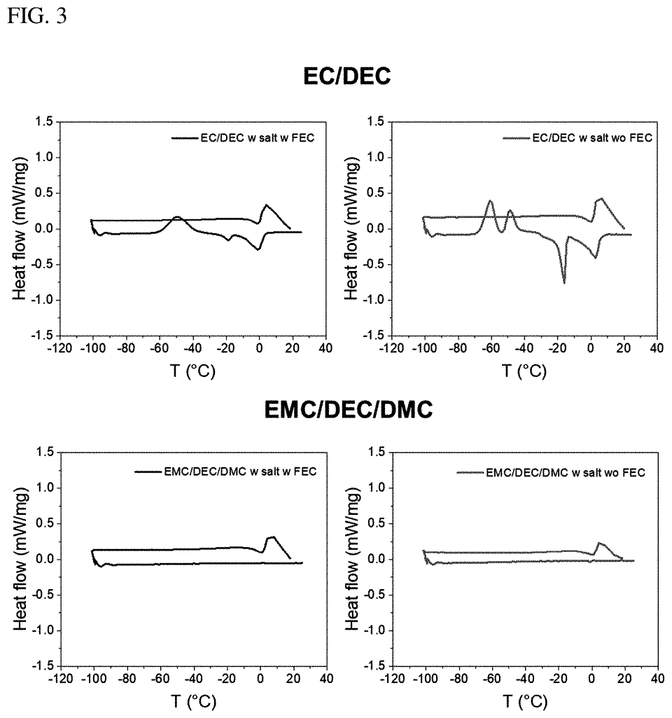

After putting 5 μL of the electrolytes of Examples 1-1 and 1-2 and Comparative Examples 1-1 and 1-2 on an aluminum pan for DSC in a glove box, the pan was sealed using a hermetic lid and a sealing machine to avoid exposure to moisture and oxygen in the air. The sealed aluminum pan was loaded in a DSC (differential scanning calorimetry, Netzsch) and, after keeping at −100° C. for 10 minutes, heat flow was measured while raising temperature to 25° C. at a rate of 5° C./min. The result is shown in FIG. 3.

FIG. 3 shows a differential scanning calorimetry (DSC) analysis result of the electrolytes prepared in Example 1-1, Example 1-2, Comparative Example 1-1 and Comparative Example 1-2.

Referring to FIG. 3, heat flow associated with liquid-solid transition was observed around 0° C. and −18° C. for the commercial EC/DEC-based electrolytes of Comparative Examples 1-1 and 1-2. Heat flow was observed around −20° C. and from −5° C. to 0° C. regardless of the addition of FEC, suggesting that the frozen electrolyte began to melt at the corresponding temperatures. In contrast, the electrolytes of Example 1-1 and Example 1-2 did not show any phase transition from −100° C. to 25° C. with no heat flow observed, suggesting that their freezing points are below −100° C. These temperatures are below the freezing points of the ternary acyclic alkyl carbonate mixture solvents shown in FIG. 2, which is due to the freezing-point depression owing to the dissolution of the lithium salt. Accordingly, it is expected that superior battery characteristics can be achieved by the electrolytes even at the extremely cold temperature of −40° C.

### Test Example 3. Analysis of Ion Conductivity

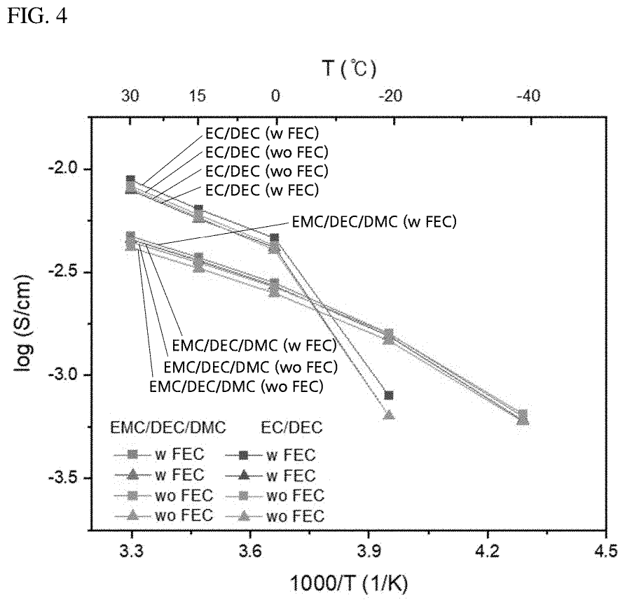

A CR2032 coin cell was prepared using stainless steel (L316) current collectors as a cathode and an anode, using a 0.3-mm glass fiber membrane as a separator, and using the electrolytes of Example 1-1, Example 2-1, Comparative Example 1-1 and Comparative Example 1-2. The current collector had a diameter of 16 mm and a thickness of 0.8 mm. Electrochemical analysis was performed using an SP1 potentio/galvanostat (Biologic Scientific Instruments, France) at specific temperatures. After connecting the coin cell to a potentiostat channel in a constant-temperature chamber and waiting for 60 minutes at temperatures of 30° C., 15° C., 0° C., −10° C., −20° C. and −40° C., electrochemical impedance spectroscopy (EIS) measurement was made in a frequency range from 300 mHz to 1 MHz. The result is shown in FIG. 4.

FIG. 4 shows the ion conductivity of the electrolytes of Example 1-1, Example 2-1, Comparative Example 1-1 and Comparative Example 1-2 depending on temperature. In FIG. 4, the electrolytes including FEC were marked by w, and the electrolytes not including FEC were marked by wo.

Referring to FIG. 4, it can be seen that the conductivity of the electrolytes of Comparative Example 1-1 and Comparative Example 1-2 was higher than the conductivity of the electrolytes of Example 2-1 and Example 2-1 at temperatures above zero. At low temperatures below zero, the ion conductivity of the commercial electrolytes of Comparative Examples 1-1 and 1-2 decreased rapidly whereas the ion conductivity of the electrolytes of Example 1-1 and Example 2-1 decreased gradually and was retained significantly high as compared to the commercial electrolytes.

### Test Example 4. Analysis of Ion Electrochemical Characteristics

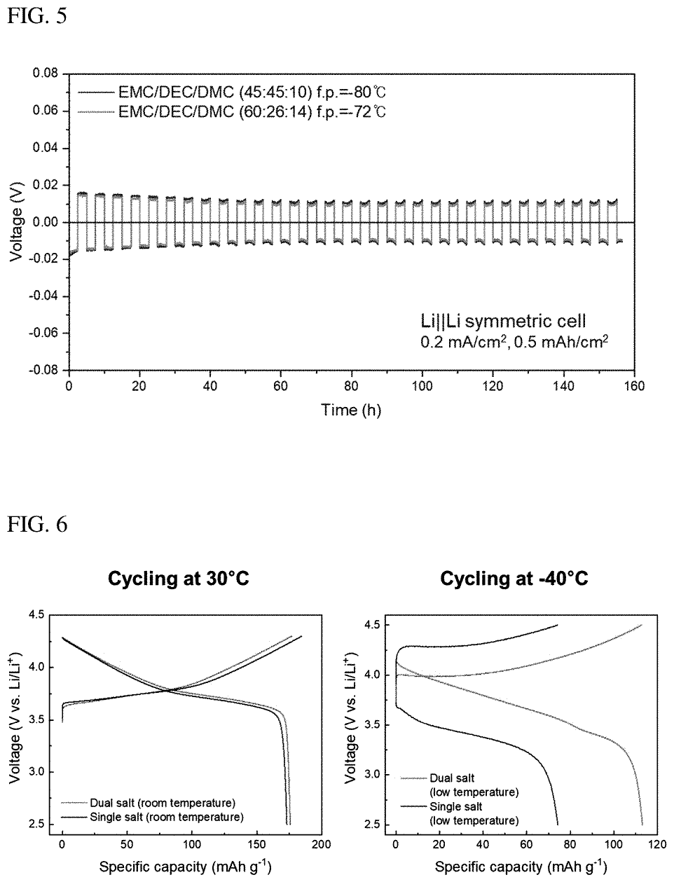

A CR2032 coin cell was prepared using punched lithium metal ribbons with a diameter of 11.3 mm (area: 1.003 cm²) as a cathode and an anode, respectively, using a 0.3-mm glass fiber membrane as a separator, and using the electrolytes prepared in Examples 1-1 and 2-1. After connecting the symmetric coin cell to a potentiostat channel in a constant-temperature chamber, charge-discharge cycles of applying a current density of 0.2 mA/cm² at 30° C. for 2 hours and 30 minutes to 0.5 mAh/cm² and then applying a current density of −0.2 mA/cm² for 2 hours and 30 minutes were repeated. The result is shown in FIG. 5. The charge-discharge cycles were set to stop when the cell was broken and the voltage reached 1.0 V. It was investigated whether the electrolyte of the present disclosure can be utilized reversibly as a lithium metal anode in a lithium secondary battery.

FIG. 5 shows a result of testing the room-temperature characteristics of the Li∥Li symmetric cells using electrolytes of Example 1-1 and Example 2-1. Referring to FIG. 5, it can be seen that the electrolytes of Example 1-1 and Example 2-1 can be charged/discharged (electrochemical lithium electrodeposition and dissolution) reversibly for 150 hours or longer owing to the high chemical stability against lithium metal confirmed in Test Example 1. That is to say, the electrolyte of the present disclosure is stable at −0.02 V versus lithium metal, and thus can be stably used in combination with lithium metal and a lithium-ion battery anode.

### Test Example 5. Evaluation of Low-Temperature Characteristics

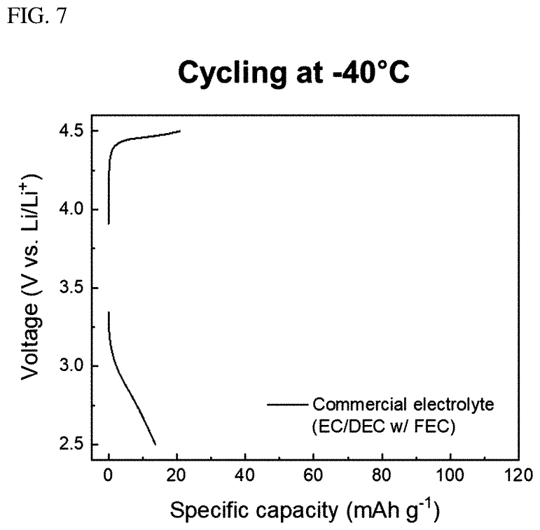

After dispersing a lithium transition metal oxide (NMC622) as an active material, conductive carbon and a PVDF binder at a weight ratio 90:5:5 in a NMP solvent, a slurry was prepared by mixing using a mixer (Thinky Mixer, Japan). After coating the slurry on an aluminum foil current collector using a doctor blade and drying in vacuo at 80° C. for 12 hours, a cathode electrode was prepared by compressing using a roll press. The cathode electrode was punched with a diameter of 11.3 mm (area: 1.003 cm²) for use as a cathode, and a lithium metal ribbon was punched with a diameter of 16 mm for use as an anode. Then, a CR2032-type half-cell was prepared using a 0.3-mm glass fiber membrane as a separator and using the electrolytes of Example 1-1, Example 1-3 and Comparative Example 1-1. The room temperature electrochemical characteristics of the half-cell were evaluated by applying a constant current density of 0.1 C at room temperature (30° C.) with an upper limit charging voltage of 4.3 V and a lower limit discharging voltage of 2.5 V. Then, the half-cell was subjected to galvanostat at −40° C. with the same current density in a constant-temperature chamber with an upper limit charging voltage of 4.5 V and a lower limit discharging voltage of 2.5 V. The result is shown in FIG. 6 and FIG. 7.

FIG. 6 shows a result of evaluating the electrochemical characteristics of the coin cells using the electrolytes of Example 1-1 and Example 1-3 at 30° C. and −40° C.

Referring to FIG. 6, it can be seen that discharge capacity of 177 and 174 mAh/g could be achieved, respectively, when the half-cells of Example 1-1 and Example 1-3 were charged and discharged at 30° C. in a voltage range of 4.3-2.5 V. When the half-cells were charged and discharged at −40° C., the discharge capacity was 114 mAh/g for Example 1-1, but the discharge capacity was 75 mAh/g for Example 1-3 wherein only one lithium salt, i.e., LiPF₆, was used. That is to say, it can be seen that the low temperature performance is improved significantly for a dual salt electrolyte wherein a lithium salt having a macroanion is used together with the LiPF₆ salt.

FIG. 7 shows a result of evaluating the electrochemical characteristics of the coin cell using the electrolyte of Comparative Example 1-1 at −40° C. Referring to FIG. 7, it can be seen that very high overpotential occurred during charge/discharge when the commercial electrolyte of Comparative Example 1-1 was used and the electrolyte could not function properly because the discharge capacity was only 14 mAh/g.

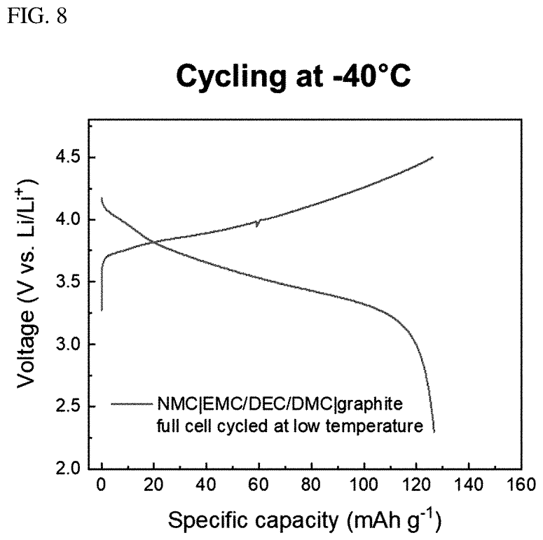

After dispersing a graphite active material, conductive carbon and a water-soluble cellulose binder at a weight ratio of 85:5:10 in distilled water, a slurry was prepared by mixing with a mixer (Thinky Mixer, Japan). A full coin cell was prepared in the same manner as in the preparation of the half-cell, except that, after coating the slurry on a copper foil current collector using a doctor blade and drying at 80° C. in the air for 60 minutes and then at 120° C. in vacuo for 12 hours, an anode electrode was prepared by compressing using a roll press. The full cell was subjected to galvanostat for three cycles with an upper limit charging voltage of 4.3 V and a lower limit discharging voltage of 2.5 V at a current density of 0.1 C. Then, the full cell was subjected to galvanostat at −40° C. with an upper limit charging voltage of 4.5 V and a lower limit discharging voltage of 2.3 V at a current density of 0.1 C. The result of testing the low temperature electrochemical characteristics is shown in FIG. 8.

FIG. 8 shows the low-temperature characteristics of the full cell of a lithium-ion battery using the electrolyte of Example 1-2. Referring to FIG. 8, it can be seen that the lithium-ion battery using the electrolyte of Example 1-2 of the present disclosure exhibits superior performance with a discharge capacity of 127 mAh/g under the condition of −40° C., voltage range of 4.5-2.3 V and current density of 0.1 C. When considering that the capacity that can be achieved with the existing half-cell at room temperature is 177 mAh/g, it retains high capacity corresponding to 72% even at −40° C.

What is claimed is:

1. An electrolyte comprising:
a mixture solvent comprising three or more different acyclic alkyl carbonate compounds; and
a mixture lithium salt comprising LiPF₆ and one or more lithium salts.

2. The electrolyte according to claim 1, wherein one of the three or more acyclic alkyl carbonate compounds is dimethyl carbonate (DMC) and each of the remaining two or more acyclic alkyl carbonate compounds is independently any of ethyl methyl carbonate (EMC), diethyl carbonate (DEC), dipropyl carbonate (DPC), methyl propyl carbonate (MPC), dibutyl carbonate (DBC), methyl butyl carbonate (MBC) and methyl pentyl carbonate (MPeC).

3. The electrolyte according to claim 2, wherein 5-45 mol % of the dimethyl carbonate (DMC) is comprised based on 100 mol % of the three or more acyclic alkyl carbonate compounds.

4. The electrolyte according to claim 1, wherein one of the three or more acyclic alkyl carbonate compounds is ethyl methyl carbonate (EMC), the other is diethyl carbonate (DEC) and the remaining one is dimethyl carbonate (DMC).

5. The electrolyte according to claim 4, wherein, based on 100 mol % of the three or more acyclic alkyl carbonate compounds,
the ethyl methyl carbonate (EMC) is comprised at 20-60 mol %,
the diethyl carbonate (DEC) is comprised at 30-80 mol %, and
the dimethyl carbonate (DMC) is comprised at 5-45 mol %.

6. The electrolyte according to claim 1, wherein the lithium salt is comprised at a concentration of 0.8-2.5 M.

7. The electrolyte according to claim 1, wherein the lithium salt comprises: lithium hexafluorophosphate (LiPF₆); and one or more of lithium bis(trifluoromethanesulfonyl)imide (LiTFSI), lithium bis(fluorosulfonyl)imide (LiFSI), lithium (fluorosulfonyl)(nonafluorobutanesulfonyl)imide (LiNFSI) and lithium triflouromethanesulfonate (LiOTf).

8. The electrolyte according to claim 7, wherein the lithium hexafluorophosphate (LiPF₆) is comprised at 30-70 mol % based on 100 mol % of the lithium salt.

9. The electrolyte according to claim 1, wherein the electrolyte further comprises 2-10 vol % of fluoroethylene carbonate (FEC) based on 100 vol % of the electrolyte.

10. The electrolyte according to claim 1, wherein
one of the three or more acyclic alkyl carbonate compounds is ethyl methyl carbonate (EMC), the other is diethyl carbonate (DEC) and the remaining one is dimethyl carbonate (DMC),
the ethyl methyl carbonate (EMC) is comprised at 25-50 mol %, the diethyl carbonate (DEC) is comprised at 40-70 mol % and the dimethyl carbonate (DMC) is comprised at 6-30 mol % based on 100 mol % of the three or more acyclic alkyl carbonate compounds,
the lithium salt is comprised at a concentration of 1-2 M,
the lithium salt comprises lithium hexafluorophosphate (LiPF₆) and lithium bis(trifluoromethanesulfonyl)imide (LiTFSI),
the lithium hexafluorophosphate (LiPF₆) is comprised at 33-67 mol % and the lithium bis(trifluoromethanesulfonyl)imide (LiTFSI) is comprised at 33-67 mol % based on 100 mol % of the lithium salt, and
2-10 vol % of fluoroethylene carbonate (FEC) is further comprised based on 100 vol % of the electrolyte.

11. A lithium-ion battery comprising the electrolyte according to claim 1.

12. An electrical device comprising the lithium-ion battery according to claim 11.

13. The electrical device according to claim 12, wherein the electrical device is a communication device, a transportation device, an energy storage device or an acoustic device.

14. A lithium-metal battery comprising the electrolyte according to claim 1.

15. A lithium-ion capacitor comprising the electrolyte according to claim 1.
